(19) United States
(12) Patent Application Publication
(10) Pub. No.: US 2007/0061298 A1
(43) Pub. Date: Mar. 15, 2007

(54) Method and apparatus for adding a search filter for web pages based on page type

(76) Inventors: Jeff K. Wilson, Austin, TX (US); Indran Naick, Cedar Park, TX (US)

Correspondence Address: IBM CORPORATION;INTELLECTUAL PROPERTY LAW, 11400 BURNET ROAD, AUSTIN, TX, 78758, US

(21) Appl. No.: 11/226,734

(22) Filed: Sep. 14, 2005

(51) Int. Cl. G06F 17/30

(52) U.S. Cl. 707/3

(57) ABSTRACT

In accordance with the teachings of the present invention, a method of providing context for a search is presented. A search query implemented in accordance with the teachings of the present invention includes a query and a context for the query. In one embodiment, the query is implemented with a keyword and context for the query is implemented with a context filter.

### BACKGROUND OF THE INVENTION

1. Field of the Invention

The present invention relates to the Internet. Specifically, this invention relates to search methods on the Internet.

2. Description of the Prior Art

The Internet includes a large number of interconnected computers that store content. Search engines are used to search the content. The search engines are based on search algorithms (i.e., methods).

A conventional search engine includes methods for performing a content search. The search engine performs an algorithm to search the content. Most conventional algorithms use keywords to perform the search. For example, a user performing a search types in a keyword into the search engine and the keyword is used to locate the content by matching the keyword to the content. The keyword is used as input and the search engine then performs the algorithm to perform the search.

There are a variety of search algorithms. For example, some search engines look for the number of occurrences of a keyword in a web page. The search engine then ranks the content (i.e., web pages) based on the number of occurrences of the keyword in the web page. If an end user searched on the keyword “volleyball,” most search engines look for the number of occurrences of the word “volleyball” in the web page and then present the web pages based on the number of occurrences of the word “volleyball” in the web page.

Should an end user desire a more-focused search, the end user may provide more keywords. The search engine would then repeat the process looking for a web page that includes the second, third, fourth keyword, etc. For example, a first search term of the keyword “volleyball” and a second search term of the keyword “leather” may produce a web page that includes occurrences of the terms “volleyball” and “leather” in the web page.

However, as many of us have observed, this is often a very frustrating approach. Most search engines provide web pages that have absolutely nothing to do with what the user is searching for. Therefore, when a user operates a conventional search engine, there are typically only a small percentage of web pages that are truly directed at what the user is searching for. The other pages may range from pages that have absolutely nothing to do with what the user is looking for to pages that have differing degrees of correlation with what the user is looking for.

Thus, there is a need for a method of performing a more effective search.

### SUMMARY OF THE INVENTION

In accordance with the teachings of the present invention, a method is presented for performing a search on the Internet. The method is implemented by adding context to a search query. In one embodiment, the context includes related information associated with the search query, such as the format, environment, or connotations associated with the search query.

In one embodiment, when a user specifies a set of keywords, he will also select whether he is looking for a form, a table, or another environmental indicator to provide context to the search. In another embodiment, keyword search terms in conjunction with the format of a web page (i.e., construction) are used to find a relevant web page. For example, implementing the method of the present invention, a search for “dishwasher pricelists” might analyze a page with the keywords “dishwasher” or “pricelists” and also analyze the construction of the web page. Pages built with an HTML table with seemingly similar data down each column including a column with repeated currency symbols might indicate a pricelist. Other web pages may have limited currency symbols to indicate a less complete list and possibly a lesser match. Still others may have phrases such as “click here to request . . . ” and not include a price list. All these web sites may be sorted differently, filtered, or ranked accordingly. As a result, using the method of the present invention, the desired web page may be found using a keyword and a context filter (i.e., table, form) that identifies the context of the search by the construction of the web page.

Another embodiment of the present invention correlates a keyword with a Universal Resource Locator (URL) or domain address. For example, locations may be correlated with URLs or domain addresses enabling searches of locations by analyzing the URL or domain address. In one embodiment, a context filter is defined and implemented by an indexer. The context filter is then used to index web content (i.e., context indexing). In this example, the context filter is the location. Context indexing might include correlating a pattern of an address (i.e., location name) with a domain name. As a result, when a domain name is located on a web page, the web site might be associated with that location. Performing a search of the location may then provide a user with suggested sites that may be found at that location (i.e., in a given city).

A method of searching, comprises the steps of indexing content based on a keyword; indexing the content based on a context filter; receiving a search request including the keyword and the context filter; searching the content; and returning search results in response to searching the content, the search results identifying the content.

A computer program product comprises a computer useable medium including a computer readable program, wherein the computer readable program when executed on a computer causes the computer to receive a search request including a keyword and a context filter, the context filter defining a web page environment that the keyword may be found in; searching content in response to receiving the request; and returning search results in response to searching the content, the search results identifying the content.

A computing system, comprises a memory, the memory storing computer instructions, the computer instructions causing the computing system to communicate a search request including a keyword and a context filter, the context filter defining a physical structure of a web page; the search request causing a server to search content in response to receiving the search request; and receiving search results in response to searching the content, the search results identifying the content.

### BRIEF DESCRIPTION OF THE DRAWINGS

FIG. 1 displays a network architecture implementing the method of the present invention.

FIG. 2 displays a computer architecture used to implement the method of the present invention.

FIG. 3 displays a flow diagram detailing one methodology of the present invention.

FIG. 4 displays a flow diagram detailing a second methodology of the present invention.

FIG. 5 displays a flow diagram detailing a third methodology of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In accordance with the teachings of the present invention, prior to facilitating a search on the Internet, a search engine performs indexing of the Internet (i.e., web page) content. For example, a search engine may index a web page, the content of the web page, the Universal Resource Locator address associated with the web page, domain names or addresses associated with a web page, etc. Indexing includes correlating the content associated with the web page with a keyword or categorizing the web page so that the web page may be accessed when a keyword is provided. In one embodiment, a software program referred to as an indexer performs the indexing. The indexer may be implemented as part of the search engine or as a separate software program.

In one embodiment, a web page is indexed based on the type of web page. Indexing the web page based on the type of web page is considered one type of context filtering. For example, a web page may be indexed as a table or a form. In this scenario, the table or form (i.e., construction of the web page) is the context filter. Once the web page is indexed, the web page may be searched using the inventive methods.

In accordance with the teachings of the present invention, the context filter defines the context or the web page environment that a keyword may be located in or the group of web pages that may be associated with a keyword. The web page environment may include the physical construction of the web page, the structural organization of the web page, the logical construction of the web page, the associated words that may be found in the web page, associated images or graphics that may be found in the web page, URLs or domain names that may be found in the web page, etc. It should be appreciated that any additional information that defines a context for a keyword is considered part of the web page environment and may be considered a context filter that is consistent with the teachings of the present invention. For example, the words “Niagra Falls” may be a keyword and the image file (i.e., JPEG file) of “Niagra Falls” found on various web pages may be part of the environment of the web page. As a result, web pages with an environment (i.e., aesthetic content) that includes a picture of the Niagra Falls may fulfill a search request for the Niagra Falls. In this scenario the context filter may be a JPEG file of the Niagra Falls.

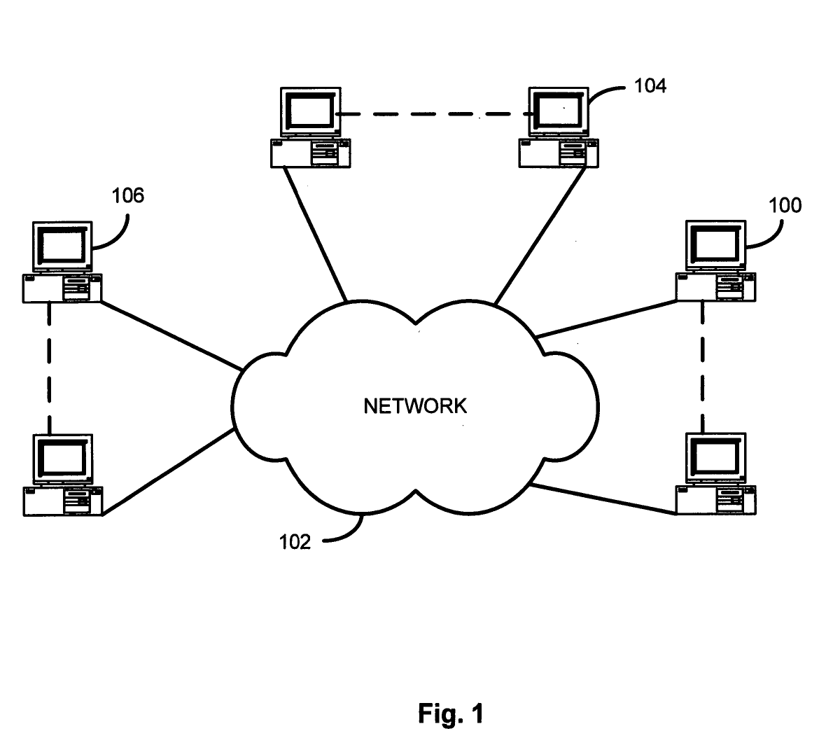

FIG. 1 displays a network architecture implementing the teachings of the present invention. In FIG. 1, an end user device is shown as 100. The end user device 100 includes any computing device used by an end user to connect to the network 102. The end user device 100 may include a hardwire connection to the Internet or a wireless connection to the network 102. Further, the end user device 100 may be implemented as a computer, cellular telephone, Personal Data Assistant (PDA), etc.

An end user operates the end user device 100 to access content servers 106. The content servers 106 represent computers that store content on the network 102. In one embodiment, the network 102 and the content servers 106 combine to form the Internet.

When an end user wants to search the Internet, the end user may operate a browser on the end user device 100 to access a search engine. In one embodiment, the method of the present invention may be implemented as part of a search engine. A search engine may be located on a search engine server 104. The inventive methods may be located on a single search engine server 104 or distributed across multiple search engine servers 104. In addition, in alternate embodiments, the inventive methods may be located on the end user device 100 and/or the content servers 106. Lastly, it should be appreciated that various combinations and permutations of the foregoing may be implemented and still remain within the scope of the present invention.

In the scenario where the search engine and the inventive methods are positioned on the search engine server 104, an end user may operate a browser on the end user device 100. In accordance with the teachings of the present invention, operating the browser includes inputting a search query including a keyword and a context filter. The end user device 100 accesses a search engine (i.e., implementing the inventive method) on the search engine server 104. The search engine server 104 searches for content stored on the content server 106. The result of the search is then presented to the end user on the end user device 100.

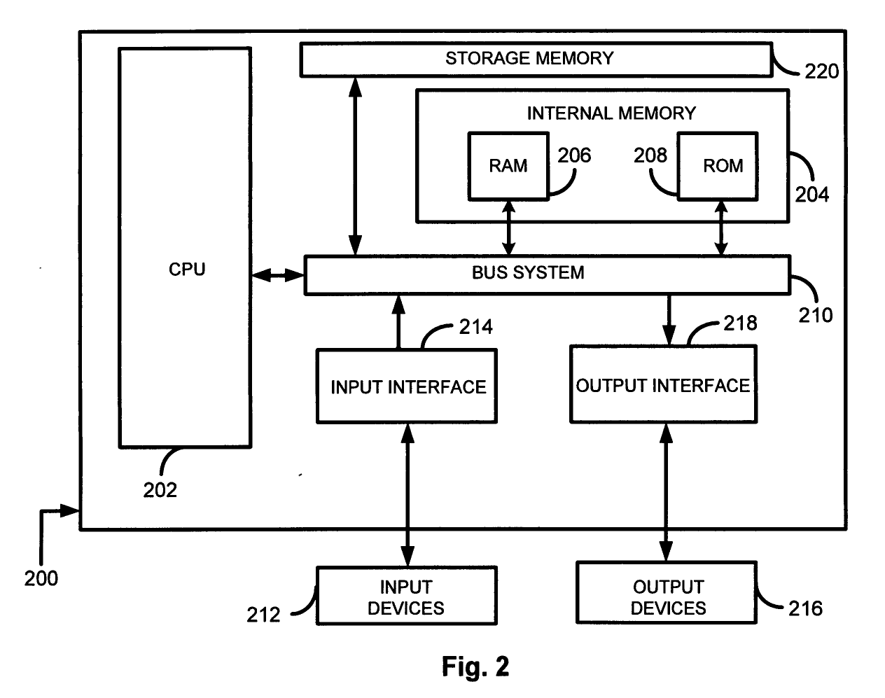

In one embodiment of the present invention, the end user device 100, the network 102, the search engine server 104, and the content servers 106 may be implemented with a computer architecture. In FIG. 2, a block diagram of a computer architecture 200 is shown. A central processing unit (CPU) 202 functions as the brain of the computer 200. Internal memory 204 is shown. The internal memory 204 includes short-term memory 206 and long-term memory 208. The short-term memory 206 may be a Random Access Memory (RAM) or a memory cache used for staging information. The long-term memory 208 may be a Read Only Memory (ROM) or an alternative form of memory used for storing information. Storage memory 220 may be any memory residing within the computer 200 other than internal memory 204. In one embodiment of the present invention, storage memory 220 is implemented with a hard drive. In one embodiment, the method of the present invention may be implemented in software stored in one of the foregoing memories (i.e., 204, 220). A bus system 210 is used to communicate information within computer 200. In addition, the bus system 210 may be connected to interfaces that communicate information out of the computer 200 or receive information into the computer 200.

Input device, such as tactile input device, joystick, keyboards, microphone, communications connections, or a mouse, are shown as 212. The input device 212 interface with the system through an input interface 214. Output device, such as a monitor, speakers, communications connections, etc., are shown as 216. The output device 216 communicates with computer 200 through an output interface 218.

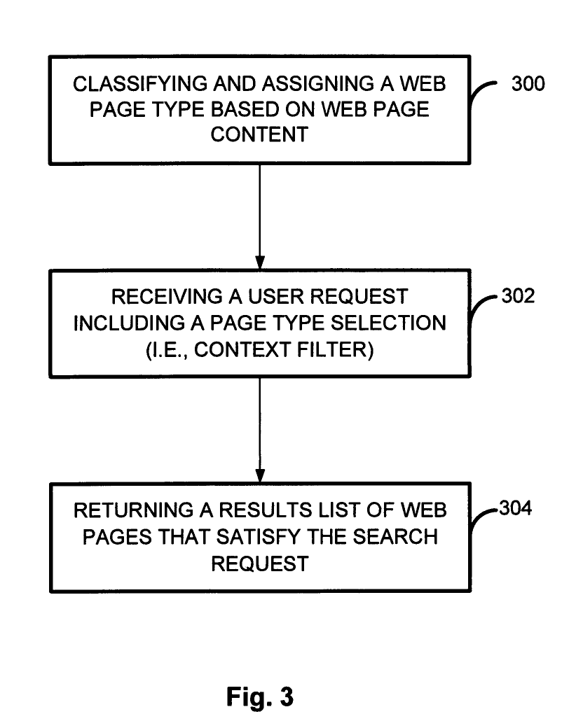

FIG. 3 displays a first methodology implemented in accordance with the teachings of the present invention. FIG. 1 will be discussed in conjunction with FIG. 3. At 300, a step of classifying and assigning a web page type is performed based on web page content. In one embodiment, a context filter may be used to classify the web page type and an indexer may be used to assign the web page type based on the context filter. A search engine operating on search engine server 104 may perform the steps of classifying and assigning the web page type.

In one embodiment, classifying a web page type may include identifying the format of the content in the web page (i.e., construction of the web page). In this scenario, a context filter includes the structure of the web page (i.e., tables, forms, etc.). For example, the content may be formatted in a table, a form, or other format. In this example, the web page type of “table,” “form,” etc. is the web page type (i.e., context filter) that would be associated with the web page.

At step 302, an end user search request is received. The end user search request includes a context filter, such as a web page type or structure indication. For example, an end user operating end user device 100 may input a search request and a context filter. The search request and context filter are communicated to the search engine server 104. The search engine server 104 then performs a method to determine the matching content. In one embodiment, this method is a matching method that is separate from the initial indexing that was performed. The matching method correlates the search request (i.e., keyword and context filter) with the content that was previously indexed. At step 304, the search engine returns search results, which include a list of web pages that satisfy the search request to the end user operating the end user device 100.

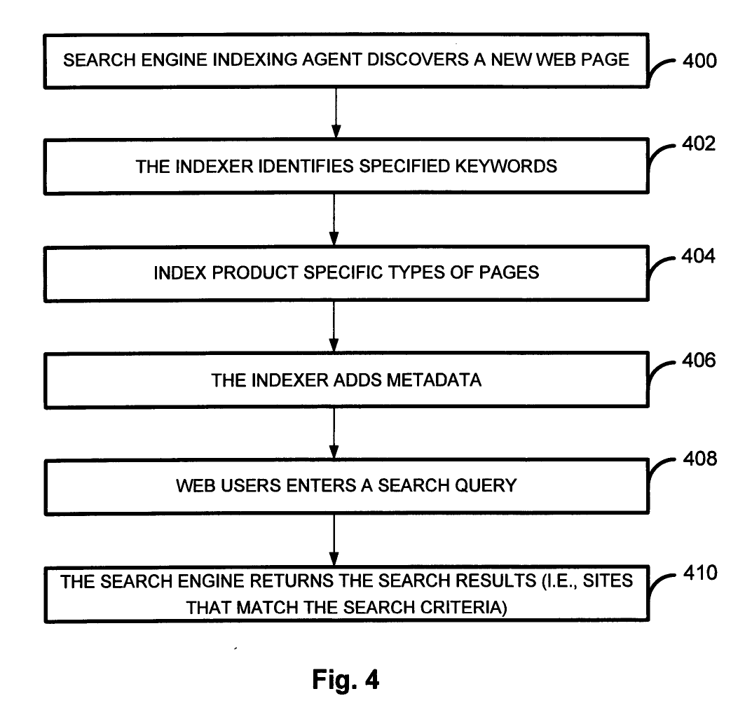

FIG. 4 displays a flow diagram detailing a product methodology implemented in accordance with the teachings of the present invention. FIG. 4 will be discussed in conjunction with FIG. 1. At step 400, a search engine indexing agent discovers a new web site. In one embodiment, a search engine indexing agent may operate on the search engine server 104. At step 402, the indexing engine searches the new web site and discovers keywords that match specified products. At step 404, a method is performed to index the web pages with the matching keywords (i.e., product specific types of pages). For example, the indexer operating on search engine server 104 may index matching products based on product specific keywords.

At step 406, the indexer performs indexing based on the context filter. In one embodiment, metadata is associated with a matching web page that associates the web page with the context filter. Indexing based on the context filtering includes putting the content into context categories, such as content formatted in forms, tables, etc (i.e., construction of the web page). Using FIG. 1, the indexer operating on search engine server 104 may index content stored in content servers 106 by categorizing the content based on a context filter. At step 408, an end user X enters a search query that may include a keyword and a context filter, such as forms or other page types. At step 410, a search engine returns the sites that meet the criteria (i.e., search results) of the keywords and the context filter.

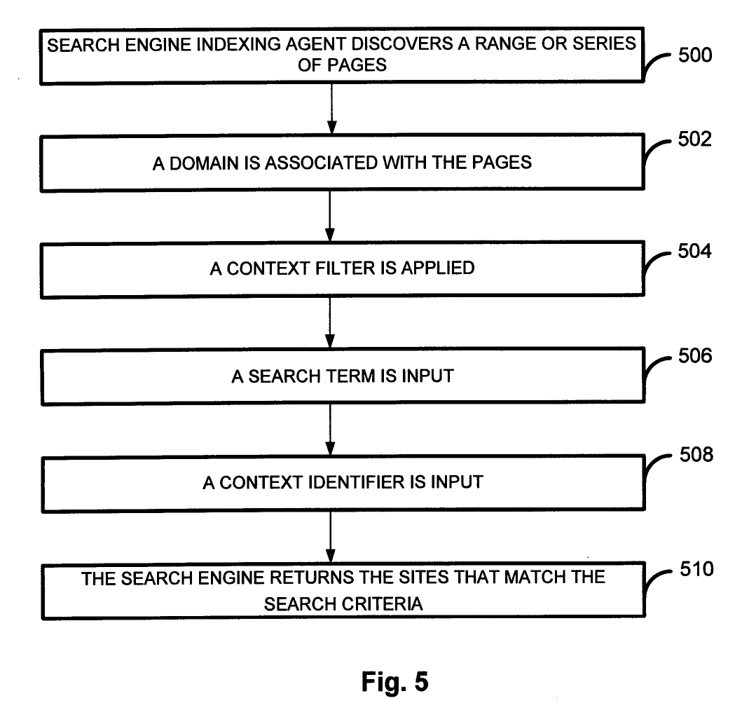

FIG. 5 displays a flow diagram detailing a location methodology implemented in accordance with the teachings of the present invention. At step 500, a search engine indexer locates a page or series of pages that include content formatted like an address (i.e., content might include ST, Ave, state abbreviations, zip codes, and may be simply formatted like an address). For example, a search engine indexer operating on search engine server 104, on a content server 106, or on end user device 100 may perform the indexing. At step 502, a domain is associated with one or more address locations. At step 504, a user may operate a user device to select a context filter, such as “filter by pattern—By location.” The context filter may be preformatted and provided to the end user in a drop down screen, etc. At step 506, a user enters a search term. For example, the user operates the end user device 100 to enter into a search field the term “art supplies”. At step 508, an end user enters a context filter. In this case, the context filter is a location. For example, the user enters, “Austin, Tex.” as a context filter into the search engine. At step 510, a list of pages is returned to the end user. In one embodiment, the search results may be categorized based on the quality of the match. For example, the first several items may be blocked off as “Suggested sites within Austin, Tex.” where these pages are associated with domains linked to locations based on the location pattern search (i.e., search term and context filter).

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

What is claimed:

1. A method of searching, comprising the steps of:
indexing content based on a keyword;
indexing the content based on a context filter;
receiving a search request including the keyword and the context filter;
searching the content; and
returning search results in response to searching the content, the search results identifying the content.

2. A method of searching as set forth in claim 1, wherein the search term is associated with a product.

3. A method of searching as set forth in claim 1, wherein the search term is associated with a location.

4. A method of searching as set forth in claim 1, wherein the context filter is a table.

5. A method of searching as set forth in claim 1, wherein the context filter is a form.

6. A method of searching as set forth in claim 1, wherein the context filter is an address.

7. A method of searching as set forth in claim 1, wherein the context filter defines the construction of a web page.

8. A method of searching as set forth in claim 1, wherein the context filter is part of a Universal Resource Locator.

9. A method of searching as set forth in claim 1, wherein the method of searching is implemented in a search engine.

10. A computer program product comprising a computer useable medium including a computer readable program, wherein the computer readable program when executed on a computer causes the computer to:
receive a search request including a keyword and a context filter, the context filter defining a web page environment that the keyword may be found in;
searching content in response to receiving the request; and
returning search results in response to searching the content, the search results identifying the content.

11. A computer program product as set fort in claim 10, wherein the keyword is associated with a product.

12. A computer program product as set fort in claim 10, wherein the key word is associated with a location.

13. A computer program product as set fort in claim 10, wherein the context filter is a table.

14. A computer program product as set fort in claim 10, wherein the context filter is a form.

15. A computer program product as set fort in claim 10, wherein the context filter is an address.

16. A computer program product as set fort in claim 10, wherein the context filter defines structural organization of a web page.

17. A computer program product as set fort in claim 10, wherein the context filter is part of a Universal Resource Locator.

18. A computing system, comprising:
a memory, the memory storing computer instructions, the computer instructions causing the computing system to:
communicate a search request including a keyword and a context filter, the context filter defining a physical structure of a web page;
the search request causing a server to search content in response to receiving the search request; and
receiving search results in response to searching the content, the search results identifying the content.

19. A computing system as set forth in claim 18, wherein the computing system is a user device.

20. A computing system as set forth in claim 18, wherein the server is a search engine server.
